(19) United States
(12) Patent Application Publication
(10) Pub. No.: US 2022/0360145 A1
(43) Pub. Date: Nov. 10, 2022

(54) ROTATING ELECTRIC MACHINE

(71) Applicant: Mitsubishi Electric Corporation, Tokyo (JP)

(72) Inventors: Hiroyuki HIGASHINO, Tokyo (JP); Yosuke UNO, Tokyo (JP); Saburo TANAKA, Tokyo (JP); Toshiaki KASHIHARA, Tokyo (JP); Yoshinobu UTSUMI, Tokyo (JP); Jun TAHARA, Tokyo (JP); Hiroyuki YAHARA, Tokyo (JP); Takaya MUTO, Tokyo (JP); Shota MORIKAWA, Tokyo (JP); Naohide MAEDA, Tokyo (JP)

(73) Assignee: Mitsubishi Electric Corporation, Tokyo (JP)

(21) Appl. No.: 17/645,205

(22) Filed: Dec. 20, 2021

(30) Foreign Application Priority Data
May 7, 2021 (JP) 2021-078948

(51) Int. Cl. H02K 9/22; H02K 9/06; H02K 11/33

(52) U.S. Cl. CPC H02K 9/227; H02K 9/06; H02K 11/33

(57) ABSTRACT

With an object, of providing a rotating electric machine such that a reduction in size can be achieved, and a balance between a cooling performance and vibration resistance can be achieved, a multiple of connection portions formed of a first connection portion and a second connection portion that mechanically connect a rotating electric machine main body and a power converter are provided on a non-external device connection portion side bracket in the rotating electric machine main body and a heat dissipating member in the power converter, cross-sectional centers of the first connection portion and the second connection portion are caused to be positioned farther to an inner diameter side than an outer diameter of a stator, and a power module is disposed between two connection portions neighboring in a circumferential direction.

### BACKGROUND OF THE INVENTION

### Field of the Invention

The present application relates to a rotating electric machine.

### Description of the Background Art

A rotating electric machine mounted in an automobile or the like includes a rotating electric machine main body and a power converter including an inverter that controls the rotating electric machine main body, and for reasons such as space conservation, ease of mounting, and reduction in size of a wiring harness that connects the rotating electric machine main body and the inverter, an electromechanical integrated rotating electric machine wherein the rotating electric machine main body arid the inverter are integrated is being developed.

Also, a rotating electric machine including a power converter that includes an inverter or a rectifying circuit includes a cooling structure that cools the power converter and a structure that attaches arid fixes the power converter to the rotating electric machine main body (for example. refer to Patent Literature 1, Patent Literature 2, and Patent Literature 3).
Patent Literature 1: Japanese Patent No. 5/729,268
Patent Literature 2: Japanese Patent No. 4,392,352
Patent Literature 3: Japanese Patent No. 5,602,214

However, a rotating electric machine disclosed in Patent Literature 1 is such that a protruding portion provided on a rear frame is disposed on an inner diameter side of a stator, and the rear frame and a power module are directly joined, meaning that when the rotating electric machine is used as a motor, heat generated by the stator is conducted to the power module, and there is concern that this will cause a temperature of the power module to worsen. Also, a rotating electric machine disclosed in Patent Literature 2 is such that a multiple of fixing studs that fix and support a power converter are disposed dispersed on an inner diameter side of a stator, because of which a radial direction cooling passage becomes blocked off, and a power module cooling performance is not necessarily optimal.

Furthermore, a rotating electric machine disclosed in Patent Literature 3 is such that a support included in a rear bracket in order that the rotating electric machine and an inverter can be easily disassembled is disposed on an outer diameter side of a stator core, because of which the rotating electric machine increases in size on the outer diameter side, causing ease of mounting in a vehicle to decrease.

Also, a connection portion is provided in a radial direction passage between the rear bracket and a heatsink, meaning that when a cross-sectional contact area of the connection portion is large, the radial direction passage between the rear bracket and the heatsink becomes smaller, and a power module cooling performance worsens. Conversely, when the cross-sectional contact area of the connection portion is small, the power module cooling performance improves, but vibration resistance decreases, and there is concern that disconnection will occur in a power module semiconductor element for which a jumper wire such as an aluminum wire bonding is used.

### SUMMARY OF THE INVENTION

A rotating electric machine disclosed in the present application is a rotating electric machine including a rotating electric machine main body, a power converter that is provided on one end of a rotary shaft of the rotating electric machine main body and exchanges electricity with the rotating electric machine main body via a current collector, and an external device connection portion that is attached to another end of the rotary shaft of the rotating electric machine main body, wherein the rotating electric machine main body includes an external device connection portion side bracket and a non-external device connection portion side bracket configuring a housing, a rotor, which is supported in such a way as to be able to rotate by the external device connection portion side bracket and the non-external device connection portion side bracket and is disposed inside the housing, a fan, which is mounted on the rotor and blows air in accompaniment to a rotation, and a stator, which is held from either axial direction side by the external device connection portion side bracket and the non external device connection portion side bracket and is disposed in such a way as to enclose the rotor, the power converter includes a power circuit unit having a multiple of power modules that include one or more set a of power semiconductor elements, a control unit that controls the power circuit unit, and a heat dissipating member that cools the power circuit unit, a multiple of connection portions formed of a first connection portion and a second connection portion that mechanically connect the rotating electric machine main body and the power converter are provided on the non external device connection portion side bracket and the heat dissipating member, cross-sectional centers of the first connection portion and the second connection portion are caused to be positioned farther to an inner diameter side than an outer diameter of the stator, and the power module is disposed between the two connection portions neighboring in a circumferential direction.

According to the rotating electric machine disclosed in the present application, a reduction in size can be achieved, and a balance between a power module cooling performance and vibration resistance in a power converter can be achieved.

The foregoing and other objects, features, aspects, and advantages of the present application will become more apparent from the following detailed description of the present application when taken in conjunction with the accompanying drawings.

### BRIEF DESCRIPTION OF THE DRAWINGS

FIG. 1 is a perspective view showing an external appearance of a rotating electric machine according to a first embodiment;

FIG. 2 is a schematic view showing a cross-section along a rotary shaft of the rotating electric machine of FIG. 1;

FIG. 3 is a schematic view of the rotating electric machine according to the first embodiment seen from a non-pulley side of a cross-section perpendicular to the rotary shaft;

FIG. 4 is a sectional view showing a main portion configuration of the rotating electric machine according to the first embodiment;

FIG. 5 is a schematic view of a rotating electric machine according to a second embodiment seen from a non-pulley side of a cross-section perpendicular to a rotary shaft;

FIG. 6 is a schematic view showing a cross-section along a rotary shaft of a rotating electric machine according to a third embodiment;

FIG. 7 is a schematic view of the rotating electric machine according to the third embodiment seen from a non-pulley side of a cross-section perpendicular to the rotary shaft;

FIG. 8 is a schematic view of a rotating electric machine according to a fourth embodiment seen from a non-pulley side of a cross-section perpendicular to a rotary shaft;

FIGS. 9A to 9E are sectional views showing enlargements of main portions of the rotating electric machines of FIGS. 2 and 7; and

FIG. 10 is a schematic view showing a modification of a rotating electric machine.

### DETAILED DESCRIPTION OF THE INVENTION

Hereafter, embodiments of the present application will be described, based on the drawings.

Identical or corresponding portions in the drawings will be described with identical reference signs allotted.

### First Embodiment

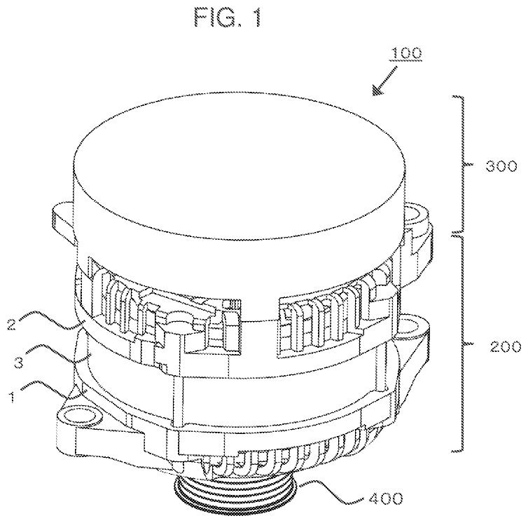

FIG. 1 is a perspective view showing an external appearance of a rotating electric machine according to a first embodiment.

In the drawing, a rotating electric machine 100 is configured of a rotating electric machine main body 200, a power converter 300, which is disposed at one end of a rotary shaft of the rotating electric machine main body 200 and exchanges electricity with the rotating electric machine main body 200, and an external device connection portion 400 attached to another end of the rotary shaft.

Herein, an exterior of the rotating electric machine main body 200 is formed of an external device connection portion side bracket 1 and a non-external device connection portion side bracket 2, which configure a housing, and a stator 3 that is fixed to and supported by the external device connection portion side bracket 1 and the non-external device connection portion side bracket 2, and the rotating electric machine main body 200 operates as a motor that drives or assists a gear device (not shown) or an internal combustion engine connected to the external device connection portion 4 GO, and furthermore, operates as a generator driven by the gear device or the internal combustion engine.

Also, the power converter 300 operates as an inverter circuit for controlling the rotating electric machine main body 200 or as a converter circuit, that converts power generated by the rotating electric machine main body 200.

Although a pulley is shown as the external device connection portion 400, various structures that can be connected to an external device can be employed.

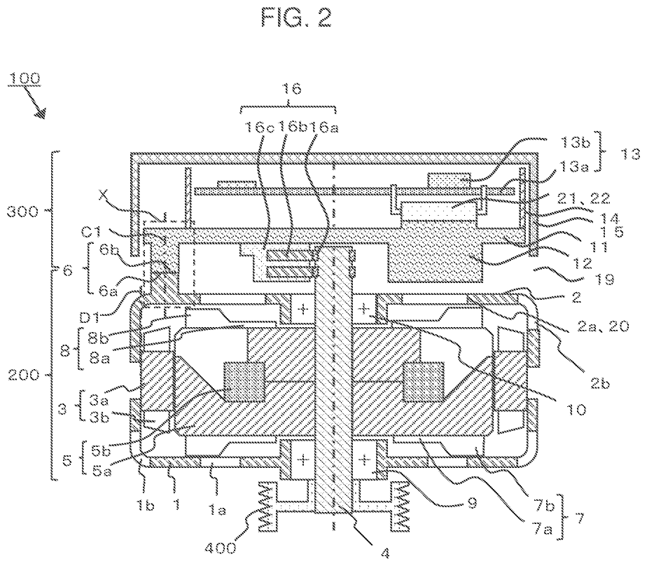

FIG. 2 is a schematic view showing a cross-section along the rotary shaft of the rotating electric machine of FIG. 1.

In the drawing, the rotating electric machine main body 200 includes the stator 3, which is fitted to and supported by the external device connection portion side bracket 1 and the non-external device connection portion side bracket 2, a roatary shaft 4, which is supported in such a way as to be able to rotate by the external device connection portion side bracket 1 and the non external device connection portion side bracket 2 across bearings 9 and 10, a rotor 5, which is attached to the rotary shaft 4 and disposed opposing the stator 3, and a current collector 16, which electrically connects the rotor 5 and the power converter 300.

Herein, the stator 3 has a circular external form, and includes a stator core 3a, and a stator winding 3b that protrudes from both end portions of the stator core 3a and is mounted on the stator core 3a. Also, the current collector 16 is configured of a slip ring 16a attached to the rotary shaft 4, a brush 16b that conducts current by coming in contact with the slip ring 16a, and a brush holder 16c that holds the brush 16b.

Meanwhile, the rotor includes a rotor core 5a supported by the rotary shaft 4, a field winding 5b wound around the rotor core 5a, and fans 7 and 8, which are attached one to either end in a rotation axis direction of the rotor core 5a, and cause a coolant flow to be generated by being driven by the rotary shaft 4.

The fans 7 and 8 have main plates 7a and 8a, which are attached to the rotor core 5a, and blades 7b and 8b, wherein the blades 7b and 8b are rotated in accompaniment to a rotation of the rotary shaft 4, causing a coolant flow to be

In the external device connection portion side bracket 1, an external device connection portion side coolant inflow portion la is formed in a rotation axis direction external device connection portion side end face and an external device connection portion side channel outflow portion 1b is formed in radial direction end face, and these are configured in such a way as to cause a coolant to flow into an interior of the external device connection portion side bracket and to cause the coolant to flow out from the interior of the external device connection portion side bracket 1, with a rotation of the external device connection portion side fan 7 as power.

Also, in the non external device connection portion side bracket 2, a non-external device connection portion side bracket coolant inflow portion 2a is formed in a rotation axis direction external device connection portion side end face and a non external device connection portion side bracket coolant outflow portion 2b is formed in a radial direction end face, and these are configured in such a way as to cause a coolant to flow into an interior of the non-external device connection portion side bracket 2 and to cause; the coolant to flow out from the interior of the non-external device connection portion side bracket 2, with a rotation of the non-external device connection portion side fan 8 as power.

Next, a configuration of the power converter 300 will be described.

The power converter 300 is fixed to a rotation axis direction non-external device connection portion side of the non-external device connection portion side bracket 2 via a connection portion 6, and includes a cover 15 that encloses a whole of the power converter 300, a power circuit unit 21, a control unit 13 that controls the power circuit unit 21, and a heat dissipating member 11 that is thermally joined in order to cool the power circuit unit 21.

The connection portion 6 is configured of a first connection portion 6a, which is provided protruding from the non-external device connection portion side bracket 2, and a second connection portion 6b, which is provided protruding on the heat dissipating member 11 and is in contact with the first connection portion 6a. Also, the control unit 13 includes a substrate 13a, and an electronic part 13b that is attached to the substrate 13a and electrically connected.

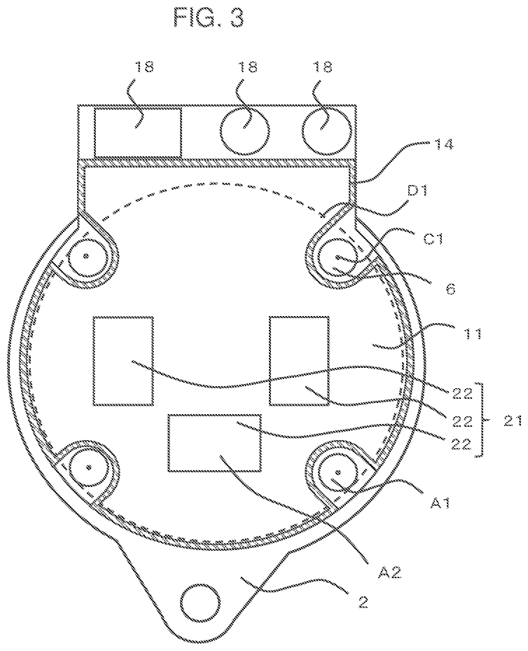

Furthermore, a multiple of fins 12 are formed on the heat dissipating member 11 with an object of increasing a cooling capacity. Also, a case 14 that encloses an outer periphery of the control, unit 13 and the power circuit unit 21 is provided, and an input/output terminal 13 (refer to FIG. 3) that connects a power module 22 to an external circuit is provided on an exterior of the case 14.

Further still, a power semiconductor element of the power circuit unit 21 is disposed farther to a radial direction outer side than an innermost diameter portion of the blade 8b of the fan 8, whereby a good cooling action can be obtained.

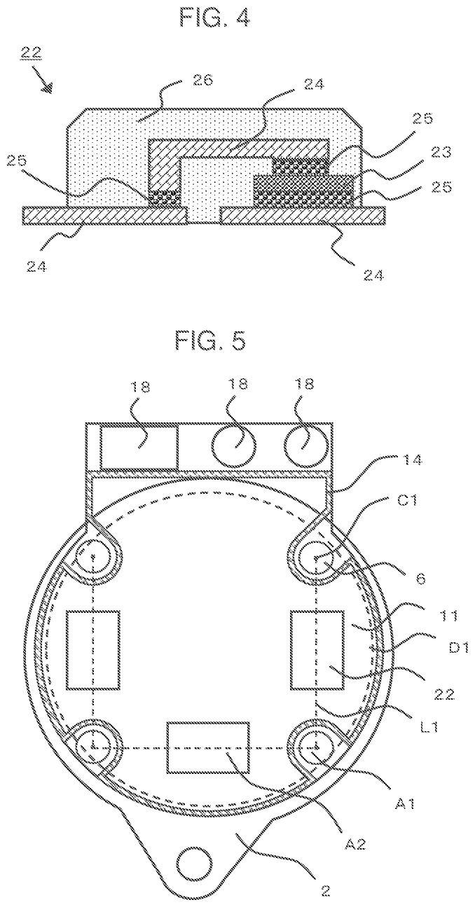

FIG. 3 is a schematic view showing an internal disposition of the power converter 300 of FIG. 2 in cross-section in a direction perpendicular to the rotary shaft. In the drawing, the power circuit unit 21 includes the power module 22, which includes one or more sets of power semiconductor elements 23 configuring upper and lower arms, and the power semiconductor element 23 is connected to a wiring member 24 across a joining member 25, as shown in FIG. 4, and configured integrated by molding using a resin material 26.

Also, the connection portion 6 is provided in such a way that a cross-sectional center C1 thereof is positioned farther to an inner side than an outer diameter D1 of the stator 3, and a multiple of power modules 22 are disposed between two connection portions 6 neighboring in a circumferential direction. Furthermore, the power modules 22 are disposed in the circumferential direction with the rotary shaft 4 as a center, and at least one connection portion 6 is disposed between two power modules 22 as seen in the circumferential direction.

By the connection portion 6 being installed inside the passage of a coolant flowing in the radial direction between the non-external device connection portion side bracket 2 and the heat dissipating member 11 in this way, the coolant flows while branching off to each power module 22, and the power module 22 can be cooled efficiently. In this case, a cross-sectional area A1 of the connection portion 6 is desirably smaller than a bottom face area A2 of a power module installed between the connection portions 6.

Also, a power converter coolant inflow portion 19 is formed in a radial direction outer peripheral face of the power converter 300, and a power converter coolant outflow portion 20 is formed in a rotation axis direction external device connection portion side end face of the power converter 300, and these are configured in such a way as to cause a coolant to flow into the power converter 300 and to cause the coolant to flow out from the power converter 300, with a rotation of the fan 8 as power.

As the power converter 300 is provided on the rotation axis direction non-external device connection portion side of the rotating electric machine main body 200, a coolant that has flowed out from the power converter coolant outflow portion 20 flows into the rotating electric machine main body 200 via the non external device connection portion side bracket coolant inflow portion 2a, which is also the power converter coolant outflow portion 20.

The rotating electric machine 100 configured as heretofore described is such that the connection portion 6 is disposed in such a way that a coolant is caused to branch off to each power module 22, because of which a cooling performance can be caused to improve, and furthermore, the power module 22 is not mounted on the connection portion 6, because of which an improvement in cooling performance can be achieved. In addition, the connection portion 6 is of a configuration where in the cross-sectional area A1 thereof is smaller than the bottom face area A2 of the power module 22, whereby a cooling passage below the power module 22 can be secured, and a cooling performance can be caused to improve. Also, as the connection portion 6 is disposed farther to the inner diameter side than the outer diameter D1 of the stator core 3a, a reduction in size and an improvement in safety can be achieved. In particular, a balance between an improvement in the power module 22 cooling performance and vibration resistance can be achieved by at least three connection portions 6 being disposed dispersed.

### Second Embodiment

FIG. 5 is a schematic view showing an internal disposition of a power converter of a rotating electric machine according to a second embodiment in cross-section in a direction perpendicular to a rotary shaft.

In the drawing, the power converter 300 is configured in such a way that the power module 22 is disposed on a line L1 linking the cross-sectional centers C1 of two connection portions 6 neighboring in the circumferential direction.

As other configurations are the same as in the first embodiment, the same reference signs will be allotted, and a description thereof will be omitted.

The rotating electric machine 100 configured in this way is configured in such a way that while the power module 22 is disposed farther to an outer peripheral side, the connection portion 6 is not disposed farther to the outer side than the outer diameter D1 of the stator 3, because of which a large region can be provided centrally in the power converter 300, with a reduction in size maintained. Consequently, for example, electric wiring that electrically connects the power module 22 and the input/output terminal 18, or a fixing member of the electric wiring, and furthermore, other electronic parts such as a reactor and a capacitor configuring a filtering circuit, can be mounted in the region.

### Third Embodiment

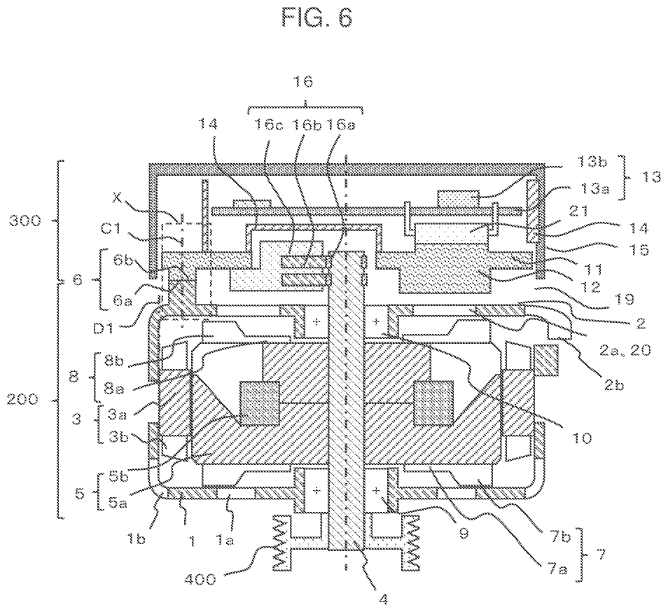

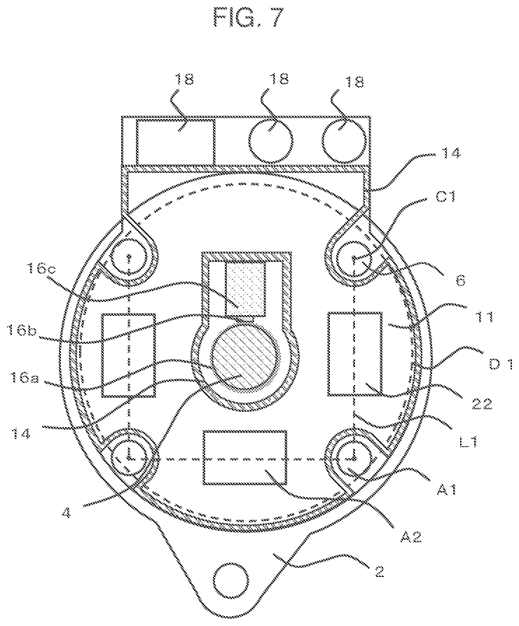

FIG. 6 is an axial direction sectional view of a rotating electric machine according to a third embodiment, and FIG. 7 is a schematic view showing an internal disposition of the power converter 300 of FIG. 6 in cross-section in a direction perpendicular to a rotary shaft.

In the third embodiment, a space is formed by providing a hole in a central portion of the heat dissipating member 11, and the current, collector 16 is disposed in the space portion. Also, the case 14, which separates the control unit 13 and the current collector 16, is provided in order that wear debris of the brush 16b does not encroach on the control unit 13 side.

As other configurations are the same as in the second embodiment, a description thereof will be omitted.

The rotating electric machine 100 configured in this way is such that while a reduction in size in the radial direction is maintained, size car also be reduced in the axial direction.

### Fourth Embodiment

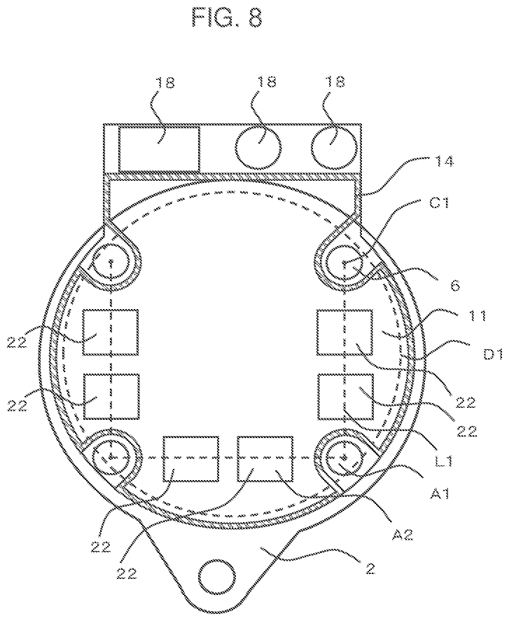

FIG. 8 is a schematic view showing an internal disposition of a power converter of a rotating electric machine according to a fourth embodiment in cross-section in a direction perpendicular to a rotary shaft.

In the fourth embodiment, two power modules 22 are disposed between the connection portions 6 neighboring in the circumferential direction.

As other configurations are the same as in the first or second embodiment, the same reference signs will be allotted to identical portions, and a description thereof will be omitted.

The rotating electric machine 100 configured in this way is such that a density of heat generated by the power module 22 can be dispersed by a multiple of power modules 22 being disposed between the connection portions 6, because of which a rise in temperature of the power module 22 can be restricted. Furthermore, freedom of disposition can be caused to increase by reducing the size of the power module.

Heretofore, embodiments of the present application have been described, but these show examples, and the present application is such that a rotating electric machine may be configured by combining characteristic configurations of the embodiments as appropriate, and various forms can be employed as described hereafter.

That is, although a cross-sectional form of the connection portion 6 is shown as being circular in the heretofore described embodiments, various forms, such as a rectangular form, a polygonal form, or an elliptical form, may be employed. Also, although a case wherein four connection portions 6 are installed at equal intervals on the same radius is shown in the drawings, disposal need not be limited to being on the same radius, the number, not being limited to four, may be any number of two or greater, and the installation intervals need not be equal intervals.

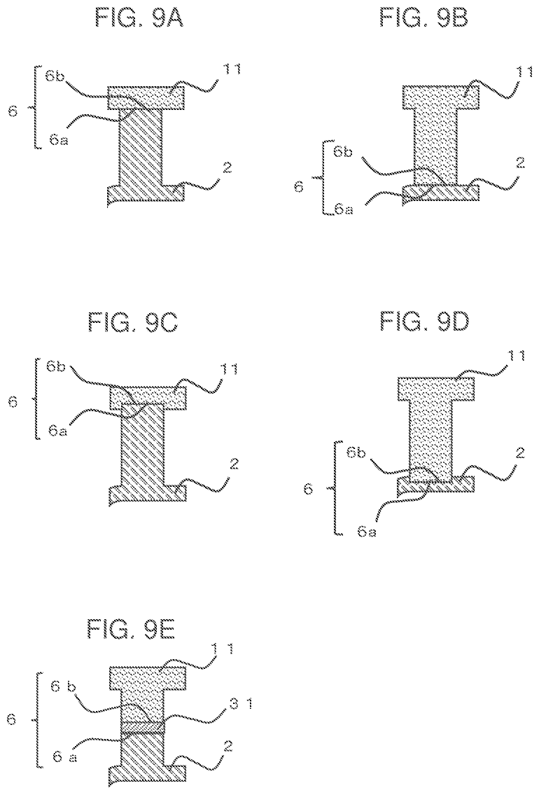

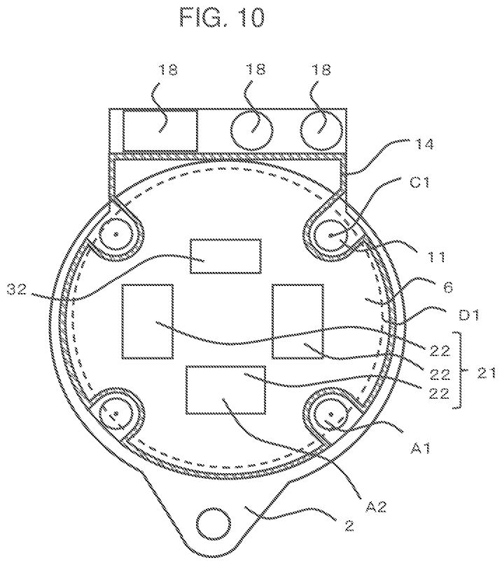

Furthermore, although the connection portion 6 shown in FIGS. 2 and 7 is such that each of the first connection portion 6a of the non-external device connection portion side bracket 2 and the second connection portion 6b of the heat dissipating member 11 is configured in such a way as to protrude, a configuration may be such that only the first connection portion 6a of the non-external device connection portion side bracket 2 is caused to protrude while the second connection portion 6b of the heat, dissipating member 11 is of a flat form, as shown in FIG. 9A, or such that only the second connection portion 6b is caused to protrude, as shown in FIG. 9B.

Also, the second connection portion 6b may be formed by providing a recessed portion in the heat dissipating member II, and the first connection portion 6a inserted into the recessed portion, as shown in FIG. 9C, or the first connection portion 6a may be formed by providing a recessed portion in the non-external device connection portion side bracket 2, and the second connection portion 6b inserted into the recessed portion, as shown in FIG. 9D.

Furthermore, an intermediate member 31 of resin or the like, whose thermal conductivity is lower or whose insulation is better than that of the non-external device connection portion side bracket 2 and the heat dissipating member 11, may be provided between the first connection portion 6a and the second connection portion 6b, as shown in FIG. 9E.

Also, a power semiconductor element consisting of six sets of upper and lower arms in order to configure two sets of three-phase full-wave rectifiers may be included as the power circuit unit 21, in which case various configurations can be employed by, for example, four power semiconductor elements consisting of two sets of upper and lower arms, or six power semiconductor elements consisting of three sets of upper and lower arms, being included in the power module 22. Also, power converters having various numbers of phase, such as a five-phase power converter having five power modules 22 consisting of one set of upper and lower arms, a six phase power converter having six power modules 22, or a seven-phase power converter having seven power modules 22, may be employed. Furthermore, the power modules 22 may be disposed mixed in such a way as to include, for example, one or more of each of a power module consisting of one set of upper and lower arms and a power module consisting of two sets of upper and lower arms,

Furthermore, an electrical circuit. 32 that controls an amount of current flowing to the field winding 5b included in the rotating electric machine main body 200 may be disposed in the heat dissipating member 11, and the electrical circuit may be an electrical circuit module whose external appearance is that of a module sealed using a sealing medium such as the resin material 26, in the same way as the power module 22. Including this kind of case too, three power modules 22 and one electrical circuit 32 may be disposed, as shown in FIG. 10, and may be aligned in any order. Also, a form wherein there are four power modules 22 rather than the electrical circuit 32 can also be employed.

What is claimed is:

1. A rotating electric machine, comprising:
a rotating electric machine main body;
a power converter that is provided at one end of a rotary shaft of the rotating electric machine main body and exchanges electricity with the rotating electric machine main body via a current collector; and
an external device connection portion that is attached to another end of the rotary shaft of the rotating electric machine main body, wherein
the rotating electric machine main body includes an external device connection portion side bracket and a non-external device connection portion side bracket configuring a housing, a rotor, which is supported in such a way as to be able to rotate by the external device connection portion side bracket and the non-external device connection portion side bracket and is disposed inside the housing, a fan, which is mounted on the rotor and blows air in accompaniment to a rotation, and a stator, which is held from either axial direction side by the external device connection portion side bracket and the non-external device connection portion side bracket and is disposed in such a way as to enclose the rotor,
the power converter includes a power circuit unit having a multiple of power modules that include one or more sets of power semiconductor elements, a control unit that controls the power circuit unit, and a heat dissipating member that cools the power circuit unit,
a multiple of connection portions formed of a first connection portion and a second connection portion that mechanically connect the rotating electric machine main body and the power converter are provided on the non-external device connection portion side bracket and the heat dissipating member, cross-sectional centers of the first connection portion and the second connection portion are caused to be positioned farther to an inner diameter side than an outer diameter of the stator, and the power module is disposed between two connection portions neighboring in a circumferential direction.

2. The rotating electric machine according to claim 1, wherein the power module is disposed on a line linking the cross-sectional centers of the two connection portions.

3. The rotating electric machine according to claim 1, wherein the connection portion is provided in a radial direction passage between the non-external device connection portion side bracket and the heat dissipating member, and is configured in such a way that a coolant branches off to each power module owing to the connection portion, and a cross-sectional area of the connection portion is smaller than a bottom face area of the power module installed between the connection portions.

4. The rotating electric machine according to claim 2, wherein the connection portion is provided in a radial direction passage between the non-external device connection portion side bracket and the heat dissipating member, and is configured in such a way that a coolant branches off to each power module owing to the connection portion, and a cross-sectional area of the connection portion is smaller than a bottom face area of the power module installed between the connection portions.

5. The rotating electric machine according to claim 1, wherein the power circuit unit includes the power semiconductor element having six sets of upper and lower arms that configure two sets of three-phase full wave rectifiers.

6. The rotating electric machine according to claim 1, wherein the power semiconductor element is configured by being molded using a resin member, and the molded resin member is disposed within an outer diameter of the stator.

7. The rotating electric machine according to claim 2, wherein the power semiconductor element is configured by being molded using a resin member, and the molded resin member is disposed within an outer diameter of the stator.

8. The rotating electric machine according to claim 3, wherein the power semiconductor element is configured by being molded using a resin member, and the molded resin member is disposed within an outer diameter of the stator.

9. The rotating electric machine according to claim 4, wherein the power semiconductor element is configured by being molded using a resin member, and the molded resin member is disposed within an outer diameter of the stator.

10. The rotating electric machine according to claim 1, wherein the power circuit unit is disposed farther to a non-external device connection portion side than the current collector.

11. The rotating electric machine according to claim 2, wherein the power circuit unit is disposed farther to a non-external device connection portion side than the current collector.

12. The rotating electric machine according to claim 3, wherein the power circuit unit is disposed farther to a non-external device connection portion side than the current collector.

13. The rotating electric machine according to claim 4, wherein the power circuit unit is disposed farther to a non-external device connection portion side than the current collector.

14. The rotating electric machine according to claim 1, wherein the power semiconductor element is disposed farther to a radial direction outer side than an innermost diameter portion of the blade of the fan.

15. The rotating electric machine according to claim 2, wherein the power semiconductor element is disposed farther to a radial direction outer side than an innermost diameter portion of the blade of the fan.

16. The rotating electric machine according to claim 3, wherein the power semiconductor element is disposed farther to a radial direction outer side than an innermost diameter portion of the blade of the fan.

17. The rotating electric machine according to claim 4, wherein the power semiconductor element, is disposed farther to a radial direction outer side than an innermost diameter portion of the blade of the fan.

18. The rotating electric machine according to claim 1, wherein a member whose thermal conductivity is lower than that of the non-external device connection portion side bracket and the heat dissipating member is included between the first connection portion of the non-external device connection portion side bracket and the second connection portion of the heat dissipating member.

19. The rotating electric machine according to claim 2, wherein a member whose thermal conductivity is lower than that of the non-external device connection portion side bracket and the heat dissipating member is included between the first connection portion of the non-external device connection portion side bracket and the second connection portion of the heat dissipating member.

20. The rotating electric machine according to claim 3, wherein a member whose thermal conductivity is lower than that of the non-external device connection portion side bracket and the heat dissipating member is included between the first connection portion of the non external device connection or side bracket and the second connection portion of the heat dissipating member.
